(19) United States
(12) Patent Application Publication
(10) Pub. No.: US 2006/0069981 A1
(43) Pub. Date: Mar. 30, 2006

(54) Data processing systems and methods for automatic entry of user data into an application program

(76) Inventor: Achim Enenkiel, Karlsruhe (DE)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/237,800

(22) Filed: Sep. 29, 2005

Related U.S. Application Data
(60) Provisional application No. 60/614,015, filed on Sep. 29, 2004.

(30) Foreign Application Priority Data
Mar. 30, 2005 (EP) 05006944.2

(51) Int. Cl. G06F 17/21

(52) U.S. Cl. 715/500

(57) ABSTRACT

Systems and methods are provided for the automatic entry of user data into an application program. In one implementation, a computer stores an embedded mark-up language document carrying user data and executes an application program. A graphical user interface displays a graphical representation of the embedded mark-up language document and a graphical representation of the application program so that a user may select the mark-up language document to initiate an automatic entry of user data into the application program.

### RELATED APPLICATIONS

This application claims the benefit of priority from U.S. Provisional Application No. 60/614,015, entitled “Data Processing Systems and Methods for Automatic Entry of User Data into an Application Program,” filed Sep. 29, 2004, and European Patent (EP) Application No. 05006944.2, filed Mar. 30, 2005, the disclosures of which are expressly incorporated herein by reference in their entireties.

### BACKGROUND

I. Technical Field

The present invention generally relates to the field of data processing and, more particularly, to the entry of user data into an application program.

II. Background Information

In conventional data processing systems, electronic data entry forms are often used for manual entry of user data into an application program. Typically, such an electronic data entry form has a number of predefined entry fields for entry of user data. For example, such electronic data entry forms can be implemented as hyper text mark-up language (HTML) web pages.

Recently, attention has been drawn to XML as a data expression means for use on the Internet. XML is an extensible meta language, and a user can uniquely define its grammar. In addition, while XML can provide logical meaning for each element, it is much easier to use than HTML (Hypertext Markup Language) for data processing. It is therefore anticipated that XML will become the standard expression method and will be used for the structural languages that will be employed for the exchange of e-commerce documents, for example. The specification for XML is contained in “W3C.Extensible Markup Language (XML) 1.0, 1998, http://www.w3.org/TR/REC-xml”.

U.S. Patent Application Publication No. 2003/0018466A1 shows a method for XML data encoding and decoding. For transferring XML data via a network, the XML data is compressed by encoding and decompressed by the recipient.

U.S. Patent Application Publication No. 2002/0073399 A1 shows a method for processing extensible mark-up language streams, such as XML streams. The method uses discrete software components mapped to text contained in the extensible mark-up language input stream. The input stream is passed and, as a tag is passed, the software component mapped to it is invoked.

U.S. Pat. No. 6,732,102 shows a method for automated data extraction and reformatting. Various data elements within a website are selected during a design phase. During a playback phase, data is extracted from the website based on the matching of the selected data elements.

Another emerging trend in the field of electronic data processing is the use of web services. Web services are an emerging technology that offers the dual promise of simplicity and pervasiveness. Web services represent the next level of function and efficiency in e-business. A Web service can be viewed as any mechanism by which an application or data processing service can be provided to other applications on the Internet.

Web services may be informational or transactional. That is, some services provide information of interest to the requestor while other services may actually lead to the invocation of business procedures. Examples of publicly available Web services today include stock quote services, services to retrieve news from Web news sources, and currency conversion services. For example, U.S. Pat. No. 6,604,135 discloses a method and system for location based web services.

For more detailed information on Web services technology reference is made to one or more of the following sources:
http://www.microsoft.com/germany/ms/msdnbiblio/show_all.asp?siteid=450884,
http://www.w3.org/TR/wsdl.html,
http://www.microsoft.com/germany/ms/msdnbiblio/show_all.asp?siteid=600570,
http://n.ethz.ch/student/iodaniel/37-310/slides/UDDI_MarcoCicolini.ppt,
http://n.ethz.ch/student/iodaniel/37-310/slides/UDDI_DominikKaspar.ppt, and
http://www.microsoft.com/germanV/ms/msdnbiblio/show_all.asp?siteid=600156.

One example of Web services are the services responsive to simple object access protocol (SOAP) messages. SOAP is an application invocation protocol that defies a protocol for exchanging information encoded as XML messages. Normally, these services are described by WSDL (Web Service Description Language) notation stored in WSDL documents.

A WSDL document can be stored in numerous ways such as in a file, in a DB2 XML registry/repository, or in a DB2 based UDDI registry, for example. UDDI (Universal Description, Discovery, Integration) is a protocol for describing Web services such that interested parties may easily discover them. Specifications for this registry and use of WSDL in the registry are available at http://www.uddi.org/. Service providers may register their services in a UDDI, specifying technical information about how to invoke the service. Often a WSDL document is stored in a UDDI registry in order to define the messages a particular Web services accepts and generates.

The design of UDDI allows enterprises that own Web service enabled applications to publish data about themselves and their services. By providing this information, UDDI implements a simplified form of searching for those interested in locating a particular service in which to fulfil an application process. The conventional UDDI search is focused on single search criteria such as business name, business location, business categories, business identifier, service type by name, and discovery URL (Uniform Resource Locator).

Various approaches for implementing Web services are known from the prior art, such as from US Patent Publication Nos. 2003/0093436 A1, 2003/0055868 A1, 2003/0055624 A1, 2003/0018661, 2003/0110242, 2003/0163513 A1, 2004/0064503 A1, 2004/0045005 A1, 2004/0003130 A1, 2003/0187841 A1.

It is a common disadvantage of known web services that they usually require a substantial amount of user interaction. Manual user interaction is tedious and error prone. Another disadvantage of manual interaction is that data which is already available in electronic form needs to be manually re-entered into the Web service. In particular, the level of manual interaction and monitoring required by state of the art Web services is costly in terms of the required human resources.

### SUMMARY

Embodiments of the present invention provide computerized systems including means for storing an embedded mark-up language document carrying user data. Such systems include a graphical user interface for displaying a graphical representation of the embedded mark-up language document and for displaying a graphical representation of an application program. Through the graphical user interface, a user can select the embedded mark-up language document in order to initiate an automatic entry of the user data into the application program.

Embodiments of the present invention may display or print a embedded mark-up language document for review of the user data that is carried by the document. When the user approves the user data contained in the embedded mark-up language document, he or she can select the embedded mark-up language document in order to initiate automatic entry of the user data into the application program. This automatic entry procedure uses the mark-up data content of the embedded mark-up language document that is machine readable in order to capture the user data.

For example, the embedded mark-up language document is received on an electronic data carrier, such as on CD-ROM or by downloading it from another computer via the Internet, as an email attachment or by other electronic data transmission channels. The embedded mark-up language document can be rendered on the graphical user interface for a user's review of its content.

After having reviewed the embedded mark-up language document, the user can close the document and select the document in order to initiate the automatic entry of the user data into an application program. For example, this can be done by clicking on the icon representing the document with the right mouse button, or by performing a drag-and-drop operation of the icon representing the document onto an icon representing an application program or an electronic data entry form used by the application program.

In accordance with an embodiment of the invention, the mark-up language is an extensible mark-up language, such as XML. Preferably, the user data is encoded according to an XML schema that is also implemented by the application program for automatically capturing of the user data from the embedded XML document.

In accordance with a further embodiment of the invention, the embedded mark-up language document is converted to a mark-up language data package for the automatic entry of the user data into the application program in response to the user's selection of the icon representing the embedded mark-up language document.

In accordance with a further embodiment of the invention, the embedded mark-up language document uses the Adobe XML architecture (see, for example, http://www.adobe.com/enterprise/xml.html).

Embodiments of the present invention also relate to data processing systems and methods that use a web service. A first computer may be used for the automatic entry of the user data into respective data entry fields of an electronic data entry form of an application program. The user data comprises an identifier of the web service, such as the uniform resource locator (URL) of the web service.

Next, the first computer initiates a data processing step that is to be performed by a second computer on the basis of the data values entered into the electronic data entry form. Alternatively, the data processing step is not to be performed by the second computer but by the first computer or another component coupled to the first computer. The initiation and/or performance or completion of the data processing step is signalled to the web service by sending of corresponding signaling data. For example, the signaling data has payment advice data of an electronic payment initiated or performed by the application program. The web service is coupled to a third computer that receives a result of the data processing step from the second computer, e.g. in the form of an XML data stream.

Embodiments of the present invention may allow the third computer to be pre-warned regarding reception of the result, e.g. payment data resulting from the data processing step performed by the first or second computer. For example, the third computer can periodically query the web service for signaling data that has been received by the web service. Alternatively, the web service implements a push service for pushing information to the third computer in response to receipt of the signaling data. The signaling data that the third computer receives from the web service can be used in various ways for control of the data processing performed by the third computer.

In accordance with another embodiment of the invention, the payment advice data contains the incoming payment details required for assigning and clearing the relevant open item. Typically, payment advice data contains the payment amount, payment date, and other information about the payment. The payment advice data has advice data items that contain information on the paid items. They also contain information used for identification purposes such as document number, reference number, billing document number, customer reference number, and so on. The payment advice data can be used during payment clearing to search for and assign open items automatically.

Embodiments of the present invention may avoid a need for transmission of payment advice notes from a payer to a payee by means of regular mail, e-mail or by fax. Known transmission methods have the disadvantage that the data contained on the payment advice notes needs to be manually re-entered into the payee's financial computer system. Embodiments of the present invention may avoid error prone and tedious manual interaction.

It is also known to transmit payment advice notes by means of an electronic message, such as EDIFACT. One of the problems associated with this is that the payer needs to know the exact address of the processing entity of the financial processing system of the payee which is to receive the payment advice note in order to enable automatic processing. The payer computer system does need to be aware of the exact format used by that processing entity of the payee's financial computer processing system.

In accordance with an embodiment of the invention, payment advice data is not only received for incoming payments but also for outgoing payments. When a direct debiting procedure is used, the payment is initiated by the payee computer rather than by the payer computer. In this instance payment advice notes are provided from the payee computer to the payer computer.

The web service can be an integral part of the third computer. In this instance the third computer has a web services interface for receiving signaling data in accordance with the HTTP request-response protocol and an internal interface to a data processing and/or control application for synchronous or asynchronous further processing of the signaling data.

Alternatively, the web service is implemented on a separate web-server computer that is loosely or closely coupled to the third computer system. For example, the web service stores the signaling data that is addressed to the third computer in a data file. The resultant data file with the accumulated signaling data is forwarded from the web service to the third computer periodically, when the size of the file has reached a predetermined limit, or at scheduled time intervals.

In another embodiment, the web service is implemented as a hub and collects signaling data for a plurality of third computer systems. In this instance, it the signaling data may be stored in a database of the web-server using a unique identifier of the third computer to which the signaling data is addressed as a database key. The database is queried periodically for new signaling data that has been received for a given third computer in order to forward the new signaling data to the third computer.

For example, embodiments of the present invention may be used for industrial control applications. In this instance, the first computer is used as a control terminal for entry of control parameters and/or control commands by an operator. The data processing step performed by the second computer is an industrial control function that provides a result which is transmitted from the second computer to the third computer after completion of the control function. The third computer is another component of the industrial control system for performance of another control function. The third computer is pre-warned regarding the execution of the control function of the second computer by means of the signaling data received by the web service that is coupled to it. This information is used in the third computer as a control parameter for execution of the third computer's industrial control functionality.

One field of application of the present invention is financial transactions. For example, a customer receives an invoice from a service provider. The invoice can be received by the customer in paper form or in electronic form, such as in the form of an XML document. The payment data is manually or automatically entered into the customer's computer for initiation of the payment procedure. After completion of the data entry into the online payment transaction form, the payment data is transmitted to a second computer for execution of the payment. For example, the second computer is a computer of the customer's bank.

The result of the data processing step performed by the bank's computer, i.e. the execution of the payment, is transmitted as corresponding payment data to the third computer, i.e. a computer of the payee. When the payment procedure is initiated the customer's computer and/or the bank's computer sends signaling data comprising payment advice data to the web service that is coupled to the payee's computer. Alternatively, the customer mails a paper form for ordering payment from his or her account to his or her bank. In this instance, the payment order data is entered into the bank's computer that takes the role of the first computer.

For example, the planned execution date of the payment procedure is communicated to the web service in order to announce the pre-scheduled payment. The payee's computer may receive an early warning regarding the scheduled payment procedure such that sending of an unnecessary payment reminder can be avoided. The scheduled payment may also be entered into the payee computer's financial planning system.

As a consequence the payee's computer is pre-warned that payment of an open invoice is imminent. This information can be used by the payee's computer to avoid sending unnecessary payment reminders, for the purpose of financial planning and/or other purposes.

Another field of application of the present invention is logistics, in particular supply chain management. For example the customer sends a purchase order to his distributor. The purchase order data is entered into the customers computer and the customers computer initiates processing of the purchase order data by the distributors computer. The customers and/or the distributors computer send signaling data to a web service that is coupled to a manufacturers computer in order to pre-warn the manufacturer regarding the purchase order. This information can be used by the manufacturer for production planning, in particular capacity planning and/or other manufacturing control purposes. After completion of the execution of the purchasing order by the distributor the computer of the manufacturer receives a corresponding confirmation from the distributors computer.

In another application scenario a customer sends an order to a supplier. This can be done in ordinary paper form by mailing the order or by electronically sending an XML-document or another electronic message to the supplier. The supplier completes the order regarding availability, delivery time and order number. Alternatively, the supplier forwards the customer's order to a manufacturer which adds these details to the order.

In accordance with an embodiment of the invention, the data values that are entered into the electronic data entry form provided by the first computer are received in electronic form, such as by means of an XML document. Further, the identifier of the web service is also received in electronic form by the first computer. In addition to the identification of the web service the XML document can also comprise the WSDL (web service description language) description of the identified web service.

In accordance with a further embodiment of the invention, the signalling data for signalling initiation of the data processing step is directly sent from the first computer to the web service. Alternatively, the signalling data is sent from the second computer to the web service.

In accordance with a further embodiment of the invention, the signalling data comprises an identifier of the second computer. The signalling data is stored in the database provided by the web service using the identifier of the third computer as a key. The third computer can periodically query the web services database in order to check if signalling data has been received and stored in the database. This can be implemented both as a push or a pull service of the web service.

It is to be noted that a database is not necessary for most applications. Rather, the signalling data is stored in a data file by the Web-Service. The data file with the accumulated signalling data is transmitted e.g. after pre-scheduled time intervals to the third computer.

In accordance with a further embodiment of the invention, the signaling data comprises a time stamp that indicates the time when the data processing step has been initiated or performed. The time information can be used as an additional control parameter by the third computer.

In accordance with a further embodiment of the invention, a computer network, such as the internet, an intranet or an extranet, provides the communication means for operatively coupling the first, second and third computers as well as the web service to the third computer.

In accordance with a further embodiment of the invention, the XML document is received by the first computer from the third computer. The XML document comprises data values and mark-up data being descriptive of the assignment of the data values to respective data entry fields of an electronic data entry form and an identifier of a web service.

For example, XML document is received from a sender computer by the first computer, the XML document containing data values, mark up data being descriptive of the assignment of data values to data entry fields of an electronic data entry form and an identifier of a Web service. The data values are read by the first computer and they are entered into respective data entry fields of an electronic data entry form identified by the mark up data.

In accordance with a further embodiment of the invention, a data processing step is initialised on the basis of the data values entered into the electronic data entry form by the first computer and the data processing step is performed using a second computer. The reading of the data values and entering the data values into respective data entry fields of an electronic data entry form is performed as a result of a drag and drop action executed in a Graphical User Interface environment. Then, the result of the data processing step is sent to the third computer by the second computer, and the signaling data is sent by the first computer to the Web service.

In accordance with a further embodiment of the invention, XML document includes a control parameter utilized for execution of said data processing step and the identifier of the Web service is an Uniform Resource Locator (URL) wherein each signaling data further comprises at least one of the data values, a time stamp identifying a date and time when at least one of the data values is sent, and an identifier identifying the sender computer.

In accordance with a further embodiment of the invention, data processing includes an account payment procedure and the account payment procedure includes a rebate feature.

In accordance with a further embodiment of the invention, an invoice is received in an electronic form, such as by means of an XML document. The XML document contains data that specifies one or more payments to be provided from the payer to the payee. In addition, the XML document can contain a link to a web service provided by the payee for collection of payment advice data. The payment procedure and the sending of the payment advice data is initiated by the user by performing a drag-and-drop operation on the XML document.

For example, the user selects the XML document and positions the XML document on an icon of the online banking software of his or hers first computer. This invokes the online banking software of the user's first computer. The online banking software automatically reads the data from the XML document that specifies the one or more payments to be provided to the payee as well as the link to the web service.

On this basis, the online banking software generates an electronic payment order that is sent to the computer of the payers bank, i.e. the second computer. In addition, the online banking software uses at least a sub-set of the data contained in the XML document and/or additional data as payment advice data and sends the payment advice data as signaling data to the Web service as identified by the link.

Alternatively, or in addition, the online banking software includes the link of the Web service in the payment order that is transmitted to the computer of the payer's bank such that the computer of the payer's bank can send the signaling data with the payment advice data to the web service provided by the payee.

Embodiments of the present invention may be implemented in applications where an early warning of a recipient's computer system regarding execution or scheduled execution of a data processing task to be performed by an external computer system positively impacts the recipient's computer system ability to execute its data processing tasks be it for the purposes of logistics, in particular supply chain management, industrial automation and control, or financial applications to name a few applications. In addition to the positive impact on the recipient's computer system performance the present invention facilitates to avoid unnecessary overheads like sending of unnecessary reminders or other messages from the recipient's computer system to one of the other involved computer systems or involved parties.

In accordance with an embodiment of the invention, an user friendly feature of drag and drop function is provided to dynamically capture the data values that become available as a result of the utilization of the Web service by a first computer and thus be able to instantaneously initiate the data processing performed by the second computer. Thus, the human error is also eliminated on the side of the receiving party. In consequence, the present invention provides an improved end-to-end data processing done in a Web service environment that allows for the improved data control and monitoring without the loss of flexibility or speed of processing that is applicable to variety of Web services including an online banking solution.

Next, the first computer initiates a data processing step that is to be performed by a second computer on the basis of the data values entered into the electronic data entry form. Alternatively, the data processing step is not to be performed by the second computer but by the first computer or another component coupled to the first computer. The initiation and/or performance or completion of the data processing step is signalled to the web service by sending of corresponding signaling data. The web service is coupled to a third computer that receives a result of the data processing step from the second computer, e.g. in the form of an XML data stream.

Embodiments of the present invention may allow the third computer to be pre-warned regarding reception of the result from the first or second computer. For example, the third computer can periodically query the web service for signaling data that has been received by the web service. Alternatively, the web service implements a push service for pushing information to the third computer in response to receipt of the signaling data. The signaling data that the third computer receives from the web service can be used in various ways for control of the data processing performed by the third computer.

The web service can be an integral part of the third computer. In this instance, the third computer has a web services interface for receiving signaling data in accordance with the HTTP request-response protocol and an internal interface to a data processing and/or control application for synchronous or asynchronous further processing of the signaling data.

Alternatively, the web service is implemented on a separate web-server computer that is loosely or fixedly coupled to the third computer system. For example, the web service stores the signaling data that is addressed to the third computer in a data file. The resultant data file with the accumulated signaling data is forwarded from the web service to the third computer periodically, when the size of the file has reached a predetermined limit, or at scheduled time intervals.

In another embodiment, the web service is implemented as a hub and collects signaling data for a plurality of third computer systems. In this instance, the signaling data may be stored in a database of the web-server using a unique identifier of the third computer to which the signaling data is addressed as a database key. The database is queried periodically for new signaling data that has been received for a given third computer in order to forward the new signaling data to the third computer.

For example, the present invention can be used for industrial control applications. In this instance, the first computer is used as a control terminal for entry of control parameters and/or control commands by an operator. The data processing step performed by the second computer is an industrial control function that provides a result which is transmitted from the second computer to the third computer after completion of the control function. The third computer is another component of the industrial control system for performance of another control function. The third computer is pre-warned regarding the execution of the control function of the second computer by means of the signaling data received by the web service that is coupled to it. This information is used in the third computer as a control parameter for execution of the third computer's industrial control functionality.

As an alternative to signaling initiation of the payment procedure, the planned execution date of the payment procedure is communicated to the web service in order to announce the pre-scheduled payment. The payee's computer may receive an early warning regarding the scheduled payment procedure such that sending of an unnecessary payment reminder can be avoided. The scheduled payment may also be entered into the payee computer's financial planning system. As a consequence, the payee's computer is pre-warned that payment of an open invoice is imminent. This information can be used by the payee's computer to avoid sending unnecessary payment reminders, for the purpose of financial planning and/or other purposes.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate various embodiments and aspects of the present invention. In the drawings:

FIG. 1 illustrates the structure of an exemplary embedded mark-up language document;

FIG. 2 illustrates the structure of the exemplary embedded mark-up language document after its conversion to a mark-up language data package;

FIG. 3 shows a block diagram of an embodiment of a computerized system, consistent with an embodiment of the invention;

FIG. 4 illustrates a data processing system for processing data values received from a sender computer in a Web-based service environment, consistent with an embodiment of the present invention;

FIG. 5 illustrates another exemplary system for processing data values received from a sender computer in a Web-based service environment consistent with an embodiment of the present invention;

FIG. 6 is a flowchart of an exemplary method, consistent with an embodiment of the present invention;

FIG. 7 illustrates an alternative embodiment of a financial system for processing account information obtained from a sender computer in a Web-based service environment, consistent with an embodiment of the present invention; and

FIG. 8 illustrates a block diagram of a further embodiment of a data processing system, consistent with an embodiment of the invention.

### DETAILED DESCRIPTION

The following detailed description refers to the accompanying drawings. Wherever possible, the same reference numbers are used in the drawings and the following description to refer to the same or similar parts. While several exemplary embodiments and features of the invention are described herein, modifications, adaptations and other implementations are possible, without departing from the spirit and scope of the invention. For example, substitutions, additions or modifications may be made to the components illustrated in the drawings, and the exemplary methods described herein may be modified by substituting, reordering, or adding steps to the disclosed methods. Accordingly, the following detailed description does not limit the invention. Instead, the proper scope of the invention is defined by the appended claims.

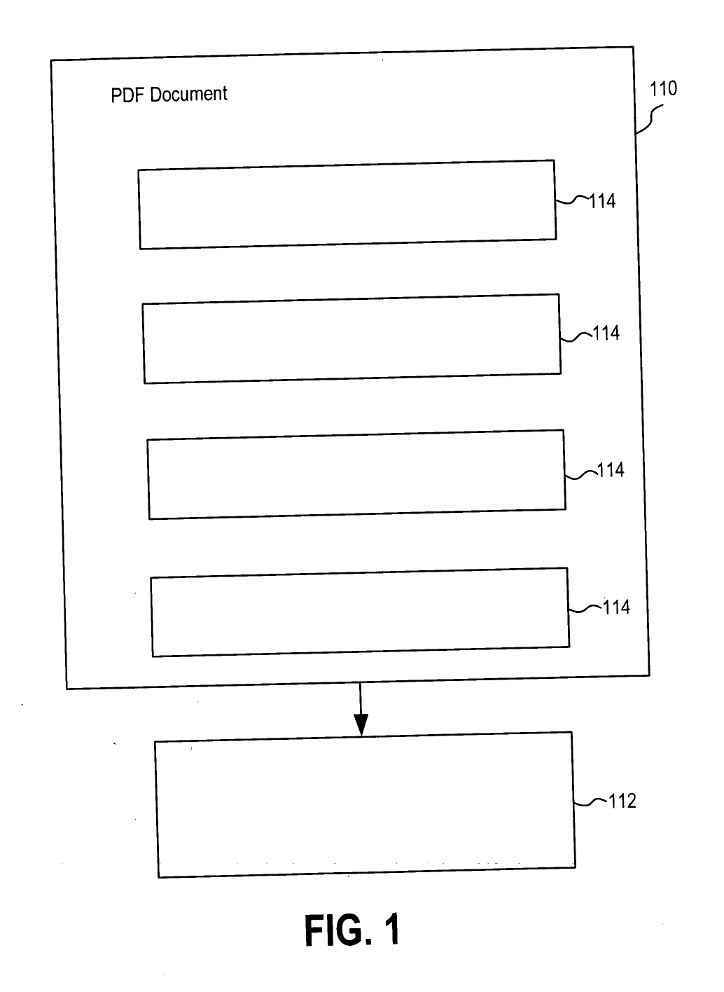

FIG. 1 shows an exemplary embedded mark-up language document 110. Embedded mark-up language document 110 can be rendered for entering of user data, for review of previously entered user data and/or for printing. In the embodiment considered here, embedded mark-up language document 110 is an embedded XML document that has embedded XML data 112.

In the example, embedded mark-up language document 110 is an electronic data entry form that has data entry fields 114 for user data. Each data entry field 114 may bean associated explanatory text that explains the user data to which the respective data entry field relates. Usually at least some of the data entry fields 114 are compulsory data entry fields; some of the data entry fields 114 may be optional and can be left open at the user's option.

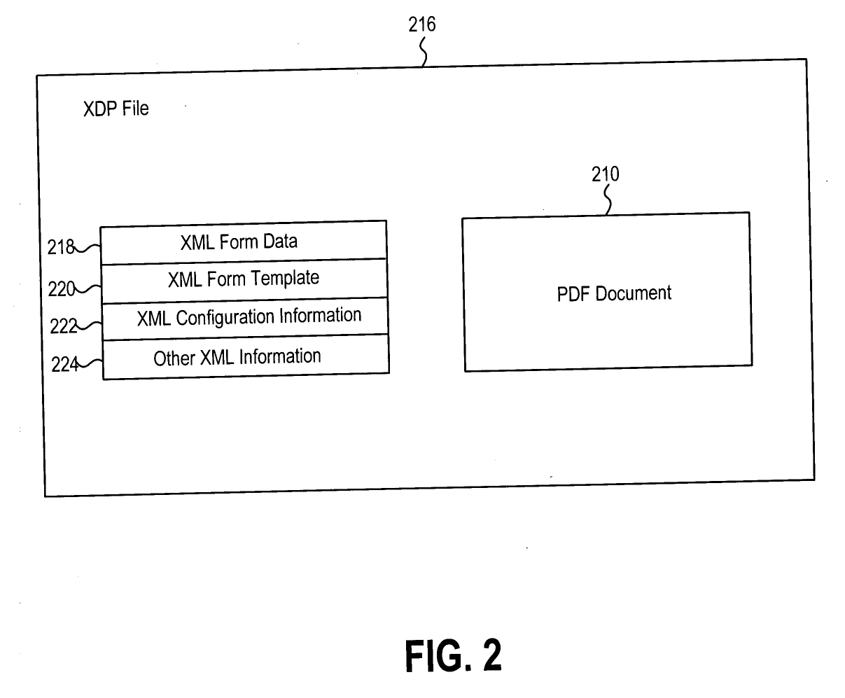

FIG. 2 shows the structure of the exemplary embedded mark-up language document 110 after its conversion to an XML data package (XDP) file 216. The XDP file 216 contains the data entry fields 114, the textual information and the graphics, if any, of the embedded mark-up language document 110 in encoded form.

In addition, XDP file 216 has XML form data 218. The XML form data 218 carries the user data that has been entered into the data entry fields 114. The user data is encoded in the XML form data 218 according to an arbitrary XML schema chosen by the developer of the embedded mark-up language document 110 during the design phase. The schema can be an industry-standard, an enterprise standard, or completely customised. Some examples of industry-standard schemas are ACORD (insurance), XBRL (finance), HL7 (healthcare), and SF424 (eGovernment).

XML form template 220 of XDP file 216 contains the mapping of the XML form data 218 to the data entry fields 114 as well as the logic that controls the interactive behaviour of the embedded mark-up language document 110, such as calculations and data validations. XML configuration information 222 of XDP file 216 is a global reference for database and web services SOAP connections. XML configuration information 222 is used by the XML form template 220 as such a global reference. Further, XDP file 216 can contain other XML information 224. Such other XML information 224 can include customer XML information such as a schema file to facilitate validation, XML digital signatures, content meta data to facilitate archiving, or data used by a custom digital document application.

The XDP file 216 is an XML file, so all XML tools, XML system interfaces, and web services can work directly with it. Also the XML data is directly accessible by such tools and interfaces. Further, the embedded mark-up language document 110, e.g. PDF document, can provide all the traditional PDF benefits of precision document layout and high fidelity printing by embedding the PDF in an XML element, i.e. XDP file 216.

The PDF representation of embedded mark-up language document 110 may be chosen when file size and transmission time are important and when the document is packaged with supplementary data or images. The XDP representation is chosen when the document and user data must travel in XML work flows, the user data needs to be manipulated with XML tools, or when it needs to be stored in an XML repository.

Adobe XML architecture may be used for the embedded mark-up language document 110, XDP file 216 and for the conversion between these two representations. Usage of the Adobe XML architecture uses an object-oriented approach to map user XML form data and data from dynamic sources to particular data entry fields in the form layout. It is to be noted that the present invention is not restricted to the Adobe XML architecture but that it can be used for other mark-up languages and respective embedded mark-up language documents as well, in particular for extensible mark-up languages.

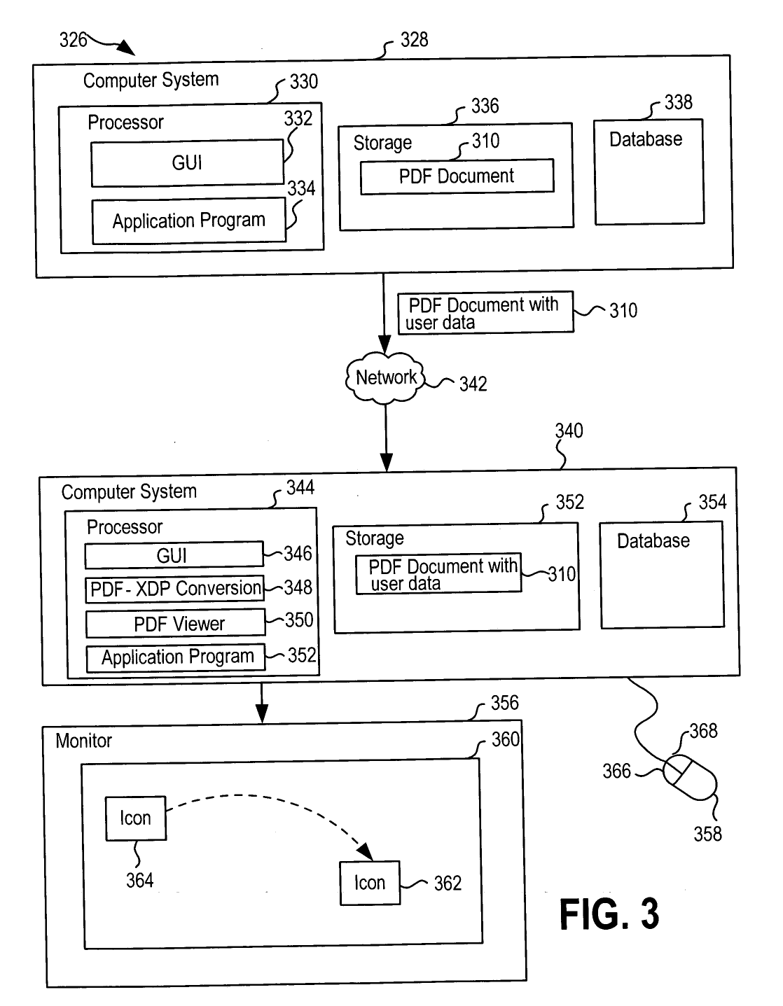

FIG. 3 shows a block diagram of a computerized data processing system 326. Data processing system 326 has computer system 328. Computer system 328 has processor 330 for execution of a program module that provides a graphical user interface 332 and for execution of an application program 334. Computer system 328 includes storage 336 for storage of the embedded mark-up language document 110 in the form of a PDF representation or as an XDP file 316. Further, computer system 328 includes database 338.

Computer system 328 is coupled to computer system 340 by means of network 342, such as by the Internet, an intranet or extranet. Computer system 340 includes processor 344, a program module for providing the graphical user interface 346, program module 348 for PDF to XDP conversion, PDF viewer program 350, and application program 352. For example, Adobe Acrobat Reader can be used as PDF viewer program 350. Further, computer system 340 has storage 352 for storage of the embedded mark-up language document 110 that carries the user data and database 354.

The monitor 356 is coupled to the computer system 340 as well as a computer mouse 358. Monitor 356 displays a window 360 that is generated by the graphical user interface 346. Window 360 shows icon 362 that represents application program 352. In operation, user data is entered into embedded mark-up language document 110 by means of computer system 328. This can be done manually by a user or automatically by invoking application program 334 that reads user data from database 338 and fills in the user data into the embedded mark-up language document 110.

The embedded mark-up language document 110 with the user data is transmitted via network 342 from computer system 328 to computer system 340 and stored in storage 352 of computer system 340. This may be done by downloading or uploading the embedded mark-up language document 110, by sending an email carrying embedded mark-up language document 110 as an email attachment, or using other data exchange means.

The user of computer system 340 can review the content of the embedded mark-up language document 110 including its user data, by invoking PDF viewer program 350 that renders the embedded mark-up language document 110 on monitor 356 or for printing the embedded mark-up language document 110. After receipt of the embedded mark-up language document 110 by computer system 340 and storing it in its storage 352, graphical user interface 346 generates icon 364 that represents the embedded mark-up language document 110. Rendering of the embedded mark-up language document 110 by means of the PDF viewer program 350 can be initiated by the user by double clicking icon 364 with the left mouse button 366 of computer mouse 358.

When the user approves the user data that is carried by the embedded mark-up language document 110 he or she can close the document and select the document for automatic entry of the user data into the application program 52. This can be done by selecting icon 364 with the left mouse button 366 and moving icon 364 onto icon 362 by means of a so-called drag-and-drop operation. “Dropping” icon 364 onto icon 362 invokes program module 348 that performs the PDF-XDP conversion.

For example, the icon 364 is shown in the file browser, such as Microsoft Explorer, of the computer system 340 for selection by the user. Preferably, the icon 364 is selected from the file browser window by clicking on it and moved onto the icon 362 that represents the application program 352 where it is “dropped,” i.e. by means of a so-called “drag-and-drop” operation. Dropping of the icon 364 causes automatic entry of the user data carried by the mark-up language document 110 into the application program 352.

As a further alternative the application program 352 has a “load document” action bar. When the user clicks on the “load document” action bar a file tree is shown from which the user select one or more mark-up language documents for entry into the application program. In the example considered here, the PDF document is transformed into the XDP file 216 that is an XML file. The application program 352 captures the user data contained in the XDP file 216 for the purpose of performing or initiating a data processing step. For example, the application program 352 stores the user data in database 354.

As an alternative to a drag-and-drop operation, the automatic entry of the user data into the application program 352 can also be initiated by clicking on the right mouse button 368 or by another suitable user input operation using the graphical user interface 346. Further, it is also possible that the user selects a group of documents for automatic entry of the respective user data.

A possible application of the above embodiment of the invention considered here is home banking and/or Internet banking. In this instance, the mark-up language document 110 is an electronic invoice. In addition, to the payment amount and an identification of the payee and the payee's bank account details, invoice number etc. the mark-up language document 110 may contain additional control information such as a fixed point of time when the payment is to be performed and/or a rebate in percentage of the payment amount to be deducted from the payment amount if certain conditions are met, e.g. payment provided within a certain deadline.

Application program 352 may be a home-banking program. When the mark-up language document 110 is entered into the application program 352 (such as by drag-and-drop or otherwise as explained above), the application program 352 automatically generates a corresponding payment order that is transmitted to a banking computer using any home-banking standard, such as HBCI. This can be done collectively for a plurality of electronic invoices in order to initiate a collective or block bank transfer.

Alternatively, the user uploads the mark-up language document 110, i.e. the electronic invoice, to an Internet-banking web site. Uploading the mark-up language document 110 causes an application program running on an Internet-banking server computer to generate a corresponding payment order.

In both cases, additional security and/or authentication features can be provided. For example, the home banking or Internet banking software checks the validity of the user's electronic signature before the payment order is generated.

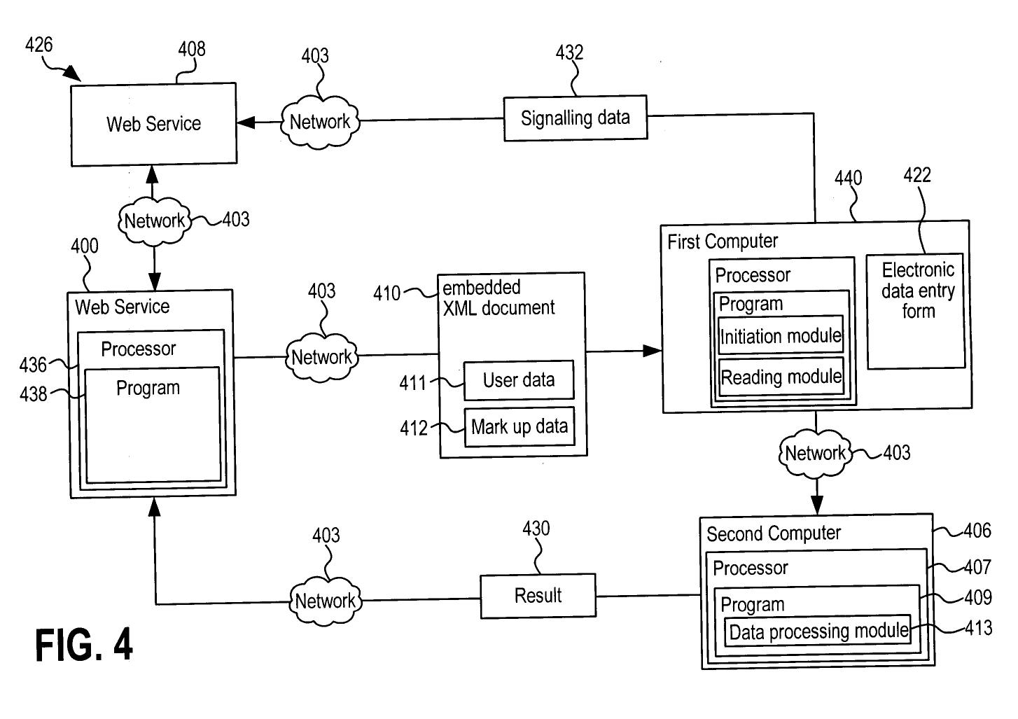

FIG. 4 illustrates another embodiment of a data processing system. The data processing system 426 of FIG. 4 has a first computer 440 that has a similar design as computer system 340 in the embodiment of FIG. 3. The first computer 440 can receive the embedded mark-up language document 410 that corresponds to the embedded mark-up language document 110 of FIGS. 1 to 3. In the embodiment considered here, embedded mark-up language document 410 is an embedded XML document that implements the Adobe XML architecture. The embedded XML document 410 carries user data 411 and mark-up data 412.

The first computer 440 is coupled through a network 403 with a second computer 406, a third computer 400 and web services 408. In the embodiment considered here, the embedded XML document 410 is sent from the third computer 400 that has a processor 436 and a program 438 to the first computer 440.

The first computer 440 has a processor 425 and a program 427, which further comprises a reading module 420, and an initiation module 424. The reading module 420 serves to capture the user data 411 included in the XML document 410 and to enter these data values into respective data entry fields of an electronic data entry form 422 identified by the mark up data 412. The initiation module 424 serves to invoke the second computer 406 in order to begin a data processing step.

The XML document 410 comprises a set of user data 411 and mark-up data 412 being descriptive of the assignment of user data values to data entry fields of an electronic data entry form. The second computer 406 has a processor 407 and a program 409. The program 407 has a data processing module 413 responsible for processing of the user data 411. When the second computer completes the data processing step, it sends the result 430 of the data processing step to the third computer 400 over the network 403. Also, a signalling data 432 is sent by the first computer 440 to the Web service 408.

Alternatively, the data processing step is not performed by the second computer but by the first computer. In operation, the XML document 410 is received by the first computer 440 from the third computer 400. The processor 425 executes a program 427 which in turn starts the reading of the user data 411 contained in the XML document 410. Then, the user values are entered automatically into respective data entry fields of an electronic data entry form 422 identified by the mark up data 412.

The capture of the user data values into the data fields of the electronic data form is accomplished be the utilization of reading module 420 allowing automatic capture of data values into the plurality of fields of an electronic data entry form 422.

Next, a program 427 having an initiation module 424 starts the data processing step by invoking the second computer 406. The second computer's processor 407 executes a program 409 having a data processing module 413 which on the basis of the data values entered into the electronic data entry form by the first computer performs the data processing step ending in a result 430 being sent to the third computer 400 over the network 403.

Simultaneously, the first computer 440 sends the signalling data 432 to the Web service 408, where the signalling data is stored in the database of the Web service 408. The signalling data is then further utilised for the controlling of the processing of the result 430 by the third computer 400 where the processor 436 executes the program 438 in order to determine when the result 430 is arriving from the second computer 406.

It is to be noted that the signalling data 432 may also be transmitted from the second computer 406 to web service 408 via network 403 for signalling initiation or completion of the data processing step performed by data processing module 413. Further, it is to be noted that XML document 410 may be provided by a forth computer that is not shown in FIG. 1, e.g. computer system 328 of FIG. 3. In other words, the source of the XML document 410 and the receiver of result 430 do not need to be identical. In fact the third and forth computers may belong to different organizational entities.

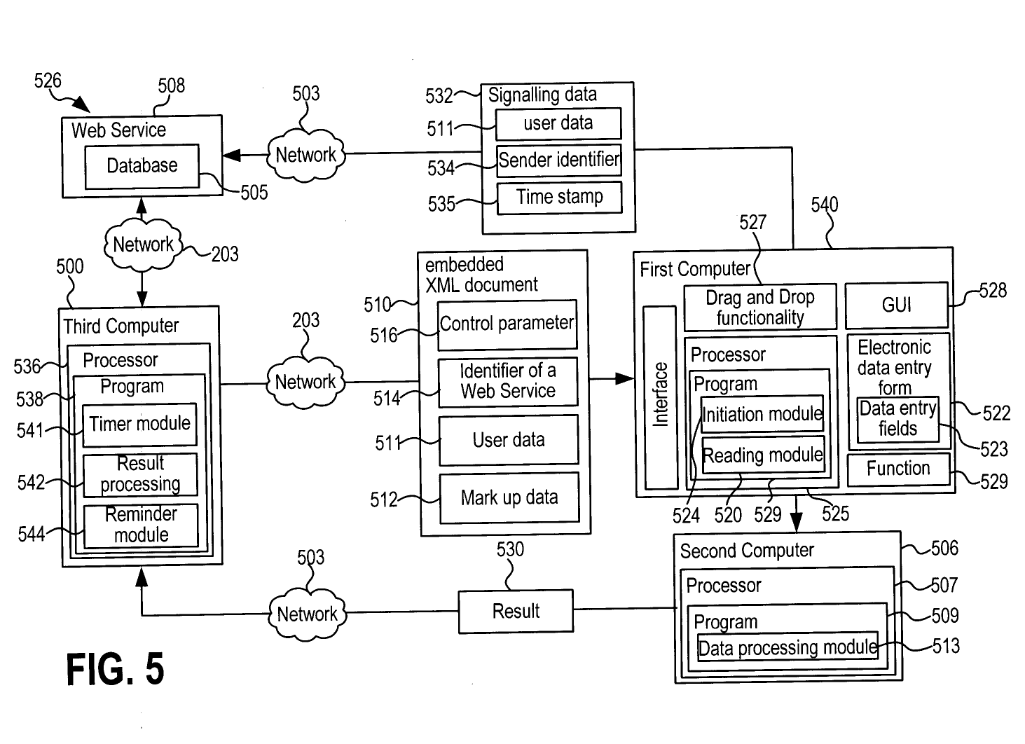

FIG. 5 illustrates a more detailed system for processing of the data values received from a sender computer in the Web-based service environment of the present invention. A third computer 500 having a processor 536, a program 538, and a plurality of modules 540 to 544 is disclosed. The third computer 500 transmits an embedded XML document 510 to a first computer 540. The embedded XML document comprises a control parameter 516, an identifier of the web service (URL) 514, other user data 511, and mark up data 512.

The first computer 540 has a processor 525 and the program modules 529, 520 and 524. The program module 529 has a reading module 520 that captures the user data values 511, 514, 516 and allows them to be entered automatically into respective data entry fields including the compulsory fields of an electronic data entry form 522. The initiation module 524 serves to execute a data processing step on the basis of the user data values 511 entered into the electronic data entry form 522 by the first computer 540. The initiation module 524 invokes a second computer 506 to start the data processing step.

The first computer 540 further comprises an interface 518 that is designed to recognise the format of the XML document 510. Program module 529 executes a function 529 that allows automatic filling out of the electronic data entry form 522 on the basis of the XML document's format. The automatic filling out of the form performed when the user uses the drag and drop functionality 527 available in the graphical user interface environment 528.

The second computer 506 has a processor which serves to execute program modules 509 and 511. Program module 509 has a data processing module 513 that is responsible for the processing of the data values. The result of the data processing step is sent to a third computer 200 utilizing a network 503. In the next step, the first computer 540 sends signalling data 532 to the web service 508 over the network 503.

The signalling data 532 comprises at least one of the user data values 511, a time stamp 535, identifying a date and a time when at least one of the data values is sent, as well as sender identifier 534. The Web service 508 comprises a database 505 for storage of signalling data 532.

In operation, utilising a network 503, a third computer 500 sends the XML document 510 to the first computer 540. The XML document 510 comprising a plurality of user data values 511, and a control parameter 516 utilized for execution of the data processing step, as well as identifier of a Web Service (URL) 514 and the mark up data 512 being descriptive of the assignment of data values to the data entry fields of an electronic data entry form is received by the first computer 540. The control parameter 516 offers a rule that is executed by the first's computer program 529 in order to determine the amount of the result 530. The data values are captured into the respective data entry fields 523 of an electronic data entry form 522 utilizing a reading module 520.

Then, the initiation module 524 invokes the second computer 506 and thus begins the data processing step, whereby the user is able to control when the data values of the XML document are entered into the electronic data entry form by using drag and drop functionality 527. It happens in such a way that in the graphical user interface 528 he moves an icon of an XML document into the software containing the program 529 and thus the initiation module 524 is activated.

The processor 507 of the second computer 506 completes processing of data utilizing a data processing module 513. The result is sent to the third computer 500 utilizing the network 503. Simultaneously, the first computer sends the signalling data 532 to the Web service 508, where the signalling data containing user data values 511, the sender identifier 534, and the time stamp 535 is stored in the database 505 of the web service 508. Also, the control parameter 516 is communicated to the Web Service by the signalling data 532.

The signalling data 532 stored in the database 505 of the web service is utilised for the controlling of the processing of the result 530. When the reminder module 544 determines that the result is overdue and that the reminder should be initiated it consults the signalling data 532 in order to find out if the result processing was initiated. If the result processing module 542 determines that signalling data contains the information that the data processing step was initiated, the reminder module invokes a timer module 541 which is set for the predetermined amount of time to allow for the processing. However, if the predetermined amount of time expires and the result 530 still does not arrive, in this case the reminder module 544 initiates sending a reminder.

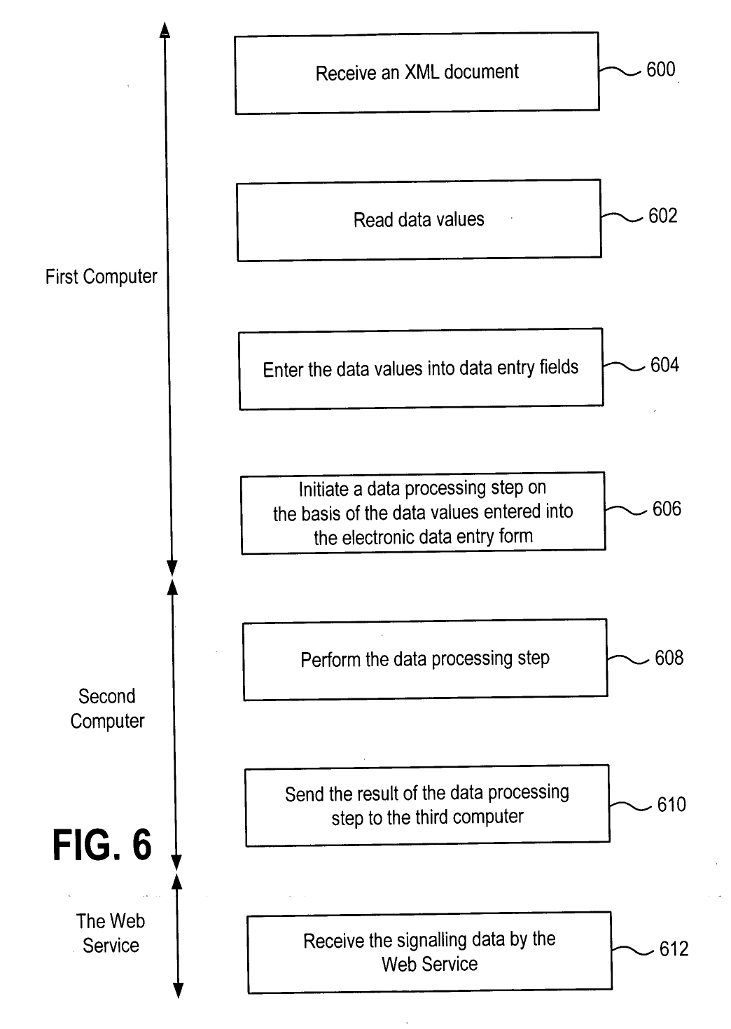

FIG. 6 shows a flow chart of an exemplary method. In step 600, an embedded XML document is received from a sender computer by a first computer, the XML document containing data values, and mark up data being descriptive of the assignment of data values to data entry fields of an electronic data entry form and an identifier of a Web service. Next, in step 602, the data values contained in the XML document are read by the reading module. In step 604, the data values are entered into respective data entry fields of an electronic data entry form identified by the mark up data by the first computer. In step 606, a data processing step is initiated on the basis of the data values entered into the electronic data entry form by the first computer. In step 608, the data processing step is performed using a second computer.

Then, in step 610, the result of the data processing step is sent to the sender computer by the second computer. In step 612, a signalling data is sent for signalling initiation of the data processing step by the first computer to the Web Service.

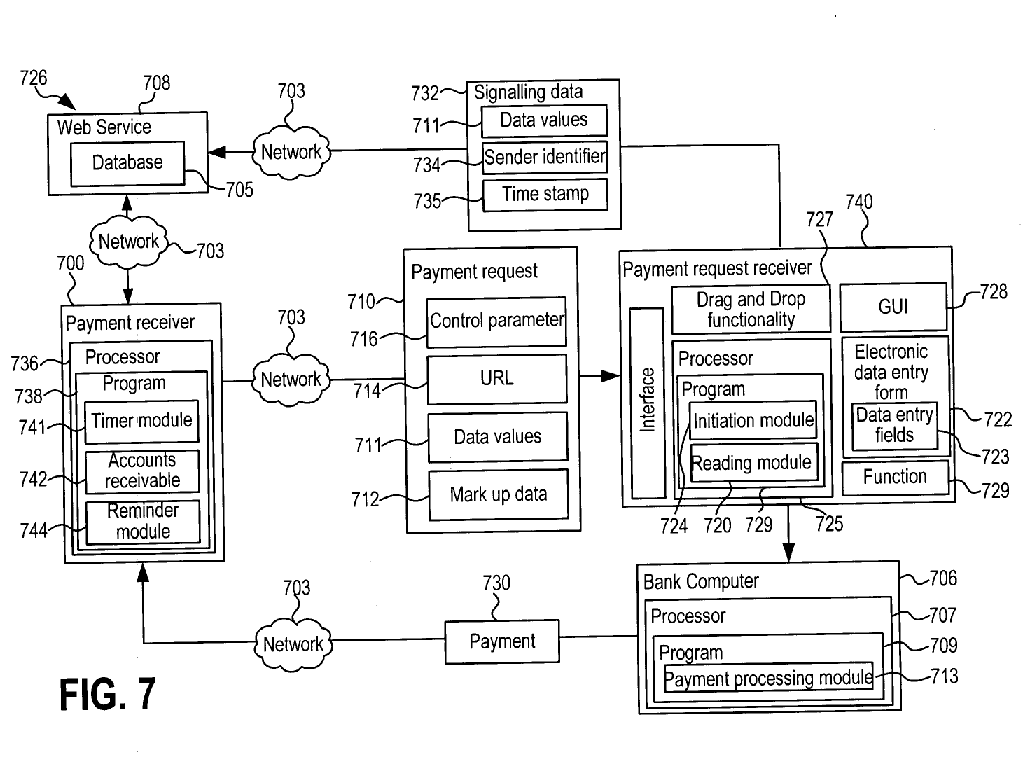

FIG. 7 illustrates an alternative embodiment of a data processing system that may be implemented as a financial/banking online system. Elements of FIG. 7 that correspond to elements of FIGS. 4 and 5 are designated by like reference numerals.

Payment receiver 700 has a processor 736, a program 738 which comprises timer module 741, accounts receivable 742, and reminder module 744. Processor 736 serves to execute program modules 740, 742 and, 744. Program module 738 has an account receivable module 742 for processing of payment 730. The payment receiver 700 sends payment request 710 utilizing a network 703 to a payment request receiver 740. The payment request 710 comprises control parameter 716, an Uniform Resource Locator (URL) 714, data values 711, and mark up data 712. The mark up data 712 is being descriptive of the assignment of data values to their data entry fields of an electronic data entry form.

According to this embodiment, a first computer is in this case a payment request receiver 740 comprising an interface 718, a processor 725, a program 729, an initiation module 724, and a reading module 720. The payment request receiver 740 further comprises an electronic data entry form 722 with the plurality of data entry fields 723, a graphical user interface 728, a drag and drop functionality 727, and a function 729.

An interface 718 recognizes the format of the payment request 710. The format contains such payment information as credit organisation, bank connection and the amount of the total payment. The processor 725 serves to execute the program modules 724 and 720. The initiation module 724 initiates a data processing step on the basis of the data values entered into the electronic data entry form 722 by the first computer, in this case a payment request receiver 740. The performance of the data processing step takes place using a second computer, in this embodiment, the second computer may be a bank computer 706.

Program module 729 has a reading module 720 which serves to capture the data values and enter them into respective data entry fields of an electronic data entry form 722. The electronic data entry form has a plurality of data entry fields 723. Program module 729 serves also to execute the function 729 which allows, on the base of format, to automatically fill out an electronic data entry form 722.

The reading of data values 711 and entering the data values into respective data entry fields 723 of an electronic data entry form 722 is performed in a response to drag and drop functionality 727 used in a graphical user interface environment 728.

Bank computer 706 has a processor 707 which serves to execute program modules 709 and 713. Program module 709 has a payment processing module 713 which performs an operation resulting in sending the payment 730 to the payment receiver 700. The payment request receiver 740 or the bank computer 706 sends the signalling data 732 to the Web service 708 utilizing a network 703. Each signalling data 732 comprises at least one of the data values 711, a time stamp 735 identifying a date and/or a time when at least one of the data values is sent, and an identifier 734 identifying the payment receiver 700. Signalling data 732 is stored in a database 705 of a web service 708 in order to be used for controlling of the processing of a payment 730.

In operation, payment receiver 700 sends payment request 710 to the payment request receiver 470 utilizing the network 703. When the payment request receiver 740 receives a payment request 710 comprising an URL; a control parameter 716, utilized for execution of payment processing step; and a mark up data 712 being descriptive of the assignment of data values to data entry fields 723, the reading of the data values 711 and entering of the data values 711 into respective data entry fields 723 takes place. The control parameter 716 provides a rule that is executed by the payment request receiver 740 in order to determine the payment amount. For example the rule allows a discount of 3 percent if the payment is performed within a week.

Next, the payment processing step is initiated on the basis of the data values entered with the help of initiation module 724 which invokes the bank computer 706 to start payment processing. The automatic filling out of electronic data entry form 722 takes place when the user using graphical user interface 728 drags and drops the icon of payment request 710 into the online banking software. The program 729 executes then the function 729 which allows on the base of the format of the payment request 710 to automatically fill out the electronic data entry form 722.

Subsequently, the processor 707 of the bank computer 706 executes the program 709 that has a payment processing module 713 that completes the payment processing step and sends the payment 730 to the payment receiver 700 utilizing the network 703.

In the next step, the payment request receiver 740 sends signalling data comprising at least one of the data values 711, a time stamp 735 identifying a date and the time when at least one of the data values is sent to the database 705 of a web service 708 and a sender identifier 734. The signalling data communicates also the control parameter 716 with the respective rules containing information about the rebate amount to the Web Service. Subsequently, the signalling data 732 is stored in a database 705, in order to be used for controlling of the processing of a payment by accounts receivable 742.

As an alternative to sending the signalling data after completion of the payment processing step, the signalling data is already sent when the order for performance of the payment processing step is generated or sent to the bank computer 706 by request receiver 740 or when the order is received by bank computer 706. In this instance the signalling data may include the date of the planned payment.

When the reminder module 744 determines that the payment 730 is overdue, instead of sending the reminder right away it attempts to find out if payment was initiated on the basis of the signalling data 732. If accounts receivable module 742 determines that the signalling data contains the information that the payment 730 was initiated, the reminder module invokes a timer module 741 which is set for the predetermined amount of time to allow for the processing. However, if the predetermined amount of time expires and the payment still does not arrive, in this case the reminder module 744 initiates sending a reminder.

Utilizing the signalling data 732 which communicates also the control parameter 716 with the rules governing the payment amount allows the incorporation of a rebate feature in the account payment procedure allowing different amount of a discount, for example 3%, 5% or 10% based on the amount of time that passes until the actual payment 730 is received.

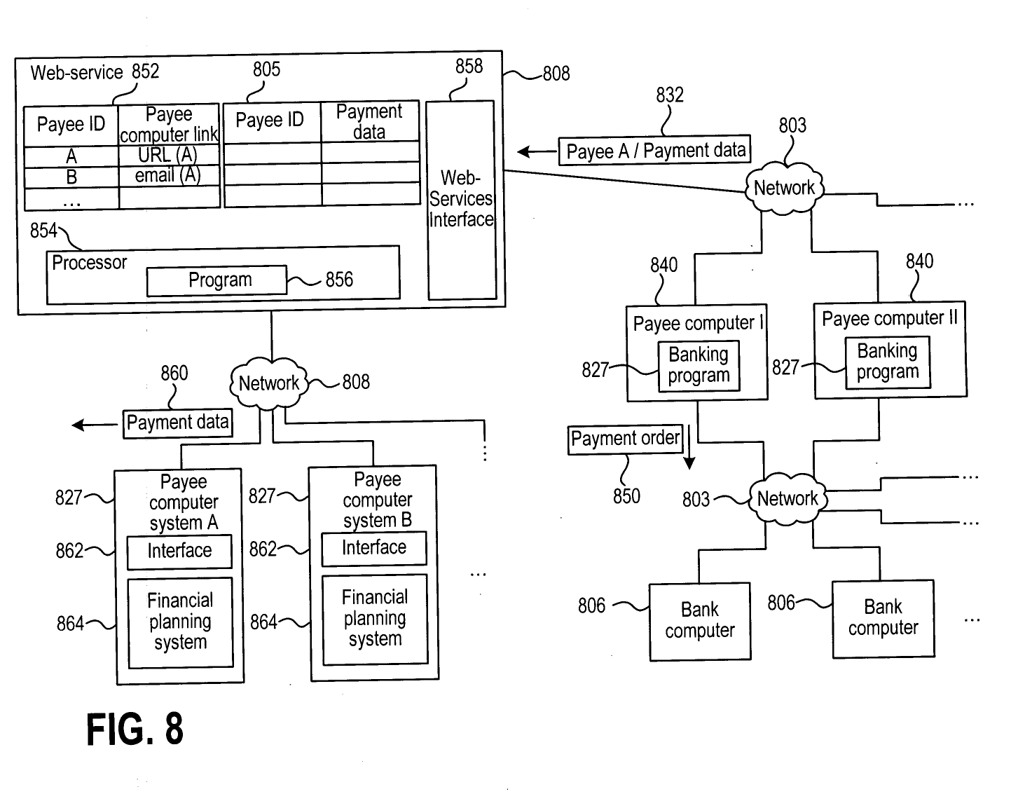

FIG. 8 shows a block diagram of an alternative embodiment. The embodiment of FIG. 5 includes a plurality of first computers 840 that belong to respective payers 1, 11, . . . Each one of the first computers 840 has a banking program 827 for entering a payment order 850. Likewise a plurality of bank computers 806 are coupled to the plurality of first computers 840 via internet 803.

The first computers 840 of the payers and/or the bank computers 806 can send signalling data 832 to web-server 808 via internet 803. The signalling data 832 includes at least an identifier of the payee that is to receive the payment and payment data, such as the amount of the payment and a pre-scheduled date when the payment procedure is to be executed and/or payment is expected to be received by the payee.

Web-server 808 has storage 805 for storage of the signalling data it has received for the various payees that are registered in table 852. Table 852 has an entry for each registered payee comprising the payee's identifier and address information regarding the payees computer, such as the payee's computer URL, email address or other link information for sending electronic data.

Web-server 808 has processor 854 for execution of computer program 856. Web services interface 858 of web-server 808 serves for communication in accordance with the HTTP request-response protocol via internet 803, in particular for receiving the signalling information 832. A plurality of third computers 800 belonging to respective payees A, B . . . are coupled to web-server 808 via internet 803. Each of the third computers 800 has a web-interface 862 and a financial planning system 864.

In operation one of the payers enters a payment order into its computer system. Without restriction of generality payer I is considered in the following. In response to the payer's I entry of the payment data into banking program 827 payment order 850 is transmitted via internet 803 to payer's I bank's computer, i.e. one of the computers 806. In addition, signalling data 832 is sent from payer's computer 840 to web-server 808 via internet 803. Alternatively, the bank computer 806 sends signalling data 832 after receipt of payment order 850. Signalling data 832 is received by web services interface 858 of web-server 808 and is entered into storage 805. Consecutively, web-server 808 may receive a sequence of additional signalling data 832 from various computers 840 of other payers or from various other bank computers 806. The respective signalling data is collected in storage 805 of web-server 808 using the respective payee identifiers as a key.

The accumulated signalling data that is stored in storage 805 is transmitted to the respective payee computer systems 800 at periodic time intervals, each time new signalling data comes in, when the accumulated signalling data has reached a given size, at prescheduled points of time or using other trigger criteria. For example, program 856 processes each entry of table 852 by reading the respective accumulated payment data from storage 805 and sending the payment data as payment data 860 to the link given in table 852 for the respective payee via internet 803 to the respective payee's computer system 800. In the example considered here, the payment data 860 of signalling data 832 is read from storage 805 and sent to the URL of payee computer system A 800 where it is received by interface 862. Payment data 860 is entered into financial planning system 864.

The foregoing description has been presented for purposes of illustration. It is not exhaustive and does not limit the invention to the precise forms or embodiments disclosed. Modifications and adaptations of the invention will be apparent to those skilled in the art from consideration of the specification and practice of the disclosed embodiments of the invention. For example, the described implementations include software, but systems and methods consistent with the present invention may be implemented as a combination of hardware and software or in hardware alone. Examples of hardware include computing or processing systems, including personal computers, servers, laptops, mainframes, micro-processors and the like. Additionally, although aspects of the invention are described for being stored in memory, one skilled in the art will appreciate that these aspects can also be stored on other types of computer-readable media, such as secondary storage devices, for example, hard disks, floppy disks, or CD-ROM, the Internet or other propagation medium, or other forms of RAM or ROM.

Computer programs based on the written description and methods of this invention are within the skill of an experienced developer. The various programs or program modules can be created using any of the techniques known to one skilled in the art or can be designed in connection with existing software. For example, program sections or program modules can be designed in or by means of Java, C++, HTML, XML, or HTML with included Java applets or in SAP R/3 or ABAP. One or more of such software sections or modules can be integrated into a computer system or existing e-mail or browser software.

Moreover, while illustrative embodiments of the invention have been described herein, the scope of the invention includes any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. Further, the steps of the disclosed methods may be modified in any manner, including by reordering steps and/or inserting or deleting steps, without departing from the principles of the invention. It is intended, therefore, that the specification and examples be considered as exemplary only, with a true scope and spirit of the invention being indicated by the following claims and their full scope of equivalents.

What is claimed is:

1. A system, comprising:
means for storing an embedded mark-up language document carrying user data;
processor means for executing an application program; and
a graphical user interface for displaying a graphical representation of the embedded mark-up language document and a graphical representation of the application program, wherein the application program receives a user's selection of the embedded mark-up language document and initiates an automatic entry of user data into the application program.

2. The system of claim 1, wherein the user data is encoded according to a mark-up language schema and the application program implements the mark-up language schema for the automatic entry of the user data.

3. The system of claim 1, further comprising:
means for converting the embedded mark-up language document to a mark-up language data package for the automatic entry into the application program.

4. The system of claim 3, wherein the means for converting is adapted to perform the conversion of the embedded mark-up language document to the mark-up language data package in response to the user's selection.

5. The system of claim 1, wherein the graphical user interface is adapted for entry of the user's selection by way of a drag-and-drop operation.

6. A data processing system, comprising:
a first computer for entering user data into data entry fields of an electronic data entry form, the user data comprising an identifier of a web service, the first computer comprising means for initiating processing of data on the basis of data values entered into the electronic data entry form;
a second computer for processing the data on the basis of the data values entered into the electronic data entry form and sending a result to a third computer; and
a web service coupled to the third computer, the web service adapted to receive signalling data to schedule, initiate, or complete processing the data.

7. The data processing system of claim 6, wherein the first computer is adapted to send the signalling data to the web service.

8. The data processing system of claim 6, wherein the second computer is adapted to send the signalling data to the web service.

9. The data processing system of claim 6, wherein the signalling data comprises at least one of the data values entered into the electronic data entry form, a time stamp identifying a date or time when the processing the data has been scheduled, initiated, or performed, and an identifier that identifies the third computer.

10. The data processing system of claim 9, wherein the web service comprises a database for storing the signalling data using the identifier of the third computers as a key.

11. The data processing system of claim 6, wherein the web service implements a push or a pull service for the third computer.

12. A data processing method, comprising:
storing an embedded mark-up language document carrying user data;
displaying a graphical representation of the embedded mark-up language document and a graphical representation of an application program;
receiving a user's selection of the embedded mark-up language document; and
initiating an automatic entry of the user data into the application program.

13. The data processing method of claim 12, wherein the user data is encoded according to a mark-up language schema and the application program implements the mark-up language schema for the automatic entry of the user data.

14. The data processing method of claim 12, further comprising:
converting the embedded mark-up language document to a mark-up language data package for the automatic entry of the user data into the application program.

15. The data processing method of claim 14, wherein the conversion of the embedded mark-up language document to the mark-up language data package is performed in response to the user's selection.

16. The data processing method of claim 12, wherein the user's selection is performed by a drag-and-drop operation.

17. The data processing method of claim 12, wherein the mark-up language is XML.

18. The data processing method of claim 12, wherein the application program is executed by a first computer, and further comprising:
entering the user data into data entry fields of an electronic data entry form of the first computer, wherein the user data comprises an identifier of a web service;
initiating a data processing step by the application program on the basis of the user data entered into the electronic data entry form;
sending signalling data for signalling scheduling, initiation, performance or completion of the data processing step to a web service; and
sending a result of the data processing step to a third computer, the third computer being coupled to the web service.

19. The method of claim 18, further comprising:
providing the signalling data from the web service to the third computer prior to receipt of the result by the third computer.

20. The data processing method of claim 18, wherein the mark-up language document is received from the third computer.

21. The data processing method of claim 18, wherein the signalling data is sent from the first computer to the web service.

22. The data processing method of claim 18, wherein the data processing step is performed by a second computer, and wherein the signalling data is sent from the first or the second computer to the web service.

23. The data processing method of claim 18, wherein the mark-up language document contains a control parameter for processing at least one of the data values by the first computer prior to entry into the electronic data entry form.

24. The data processing method of claim 18, wherein the data processing step comprises an account payment procedure.

25. The data processing method of claim 23, wherein the control parameter specifies a price rebate.

26. The data processing method of claim 18, wherein the identifier of the web service is a uniform resource locator (URL).

27. The data processing method of claim 18, wherein the signalling data comprises at least one of the user data entered into the electronic data entry form, a time stamp identifying a date and time when the data processing step has been scheduled, initiated, or performed, and an identifier of the third computer.

28. The data processing method of claim 27, wherein the third computer uses the identifier to query the web service.

29. A computer program product comprising computer executable instructions for performing a data processing method, the method comprising:
storing an embedded mark-up language document carrying user data;
displaying a graphical representation of the embedded mark-up language document and a graphical representation of an application program;
receiving a user's selection of the embedded mark-up language document; and
initiating an automatic entry of the user data into the application program.

30. An Internet banking server computer system, comprising:
means for receiving an embedded mark-up language document carrying payment data; and
processor means for executing an application program, wherein the application program generates a payment order when the mark-up language document is received from a client computer, wherein the payment data is uploaded from the client computer.
